(19) United States
(12) Patent Application Publication
(10) Pub. No.: US 2005/0107233 A1
(43) Pub. Date: May 19, 2005

(54) Shipping base and method of making same

(76) Inventor: Christopher John Barton, Newton, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/712,566

(22) Filed: Nov. 13, 2003

(51) Int. Cl. B31B 1/78

(52) U.S. Cl. 493/309

(57) ABSTRACT

A method of using a non-wooden material to manufacture a shipping base is disclosed. Preferably, the shipping base is made from a plurality of non-wooden boards, such as those made from recycled siding materials or a plurality of particles secured together by a resin, and assembled into a shipping base. The boards are then glued, nailed, screwed or otherwise secured together in a desired shape. Additional features, such as styrofoam pieces and securing holes can be added as needed. By using non-wooden materials to make the shipping base, import restrictions, fines and bans on the importation of wood can be avoided to minimize the cost and burden of shipping non-wooden materials.

### BACKGROUND OF THE INVENTION

The present invention relates generally to a base for shipping materials and a method of making the same.

Traditionally, wooden pallets are used to ship products. However, when products are shipped overseas, a wooden pallet is not preferable. Many countries have limitations and restrictions on the importation of wooden products, including wooden pallets. Such regulations and/or limitations increase the cost and paperwork associated with the importation of non-wooden materials when such are placed on wooden pallets. It is therefore desirable to provide a method of shipping non-wooden materials on a non-wooden shipping base.

Shipping bases are currently available in molded plastic and styrofoam. However each of these materials presents its own problems. For example, while styrofoam containers can be formed in almost any shape or size, styrofoam tends to easily crack under severe stress and is expensive to mold. Similarly, plastic shipping bases are currently molded to a predetermined shape and are much more expensive to use. It is therefore desirable to find an alternative to wooden shipping bases that avoids the fragility of styrofoam and the expense of molded materials.

It is therefore desirable to have a shipping base which is capable of enduring the bumps and gyrations of the shipping process, easily adaptable to fit any desired product, relatively simple to manufacture or construct, and low in cost.

A principle feature of the present invention is a shipping base which overcomes the problems found in the prior art.

A further feature of the present invention is a shipping base which is relatively easy to manufacture.

A still further feature of the present invention is the provision of a shipping base which is easy to modify and assemble for shipping specific products.

Another feature of the present invention is the provision of a shipping base that is relatively inexpensive to manufacture.

### SUMMARY OF THE INVENTION

The present invention relates to a shipping base that is made from a material that is not solid wood and yet is easy to assemble and low in cost. More particularly, recycled siding materials can be used to construct a non-wooden shipping base that may include holes at locations designed to accommodate and secure a product's feet.

### DESCRIPTION OF THE DRAWINGS

FIG. 1 is a perspective view of a shipping base according to the present invention.

FIG. 2 is a sectional view taken along line 2-2 of the shipping base shown in FIG. 1.

### DETAILED DESCRIPTION OF THE PREFERRED EMBODIMENT

To provide a better understanding of the invention, the preferred embodiment of the invention will now be described in detail. It is to be understood that the preferred embodiment discussed below is but one form of the invention and is not exclusive.

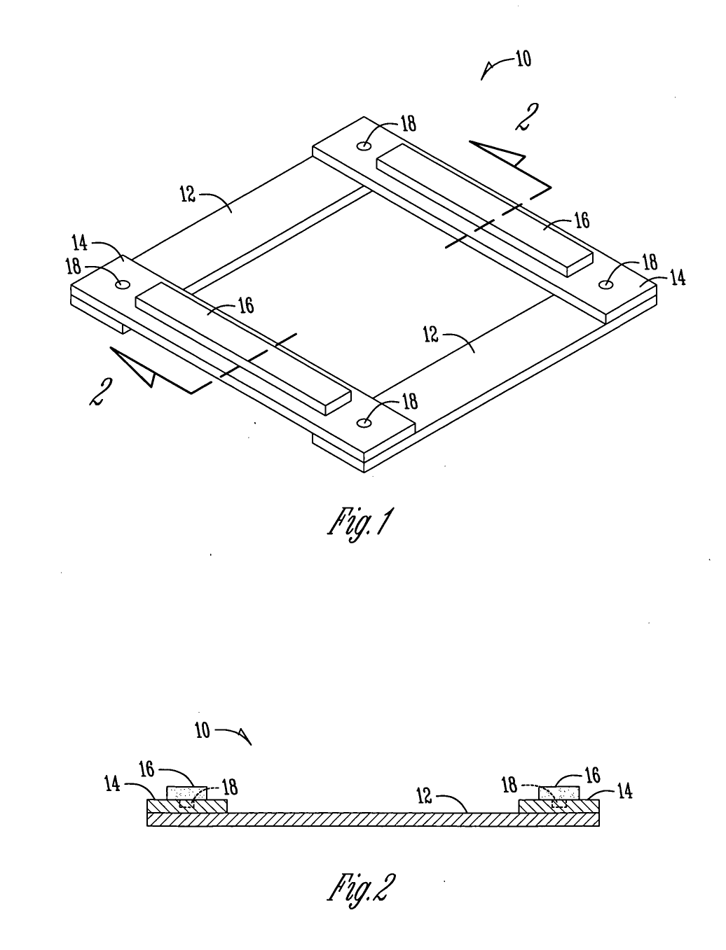

FIG. 1 is a perspective view of a shipping base 10 according to the present invention. To form the shipping base, a material that is not solid wood is chosen. Preferably, recycled siding materials, including a plurality of particles and a resin, are reused to form the shipping base 10 of the present invention.

When a resin, such as polymeric methylene diphenyl diisocyanate, is used in conjunction with particles of wood, plastic, paper, fiber or other materials, the product is typically classified as a non-wooden product and easily meets most countries' import limitations. Therefore, as used herein, non-wooden shall refer to any board or other product made of a plurality of particles and a resin.

By using recyclable siding materials, the cost of the shipping base 10 can also be minimized. Siding materials including polymeric methylene diphenyl diisocyanate are frequently disposed of at little or no cost to the recycler. Therefore, once any extraneous nails, screws or other siding connectors are removed, the siding materials can be cut into pieces as needed to form the shipping base 10. This provides a low-cost alternative to the solid wood boards in use today.

Preferably, the recycled siding materials are cut to a predetermined length to form a shipping base 10. The shipping base 10 shown in FIG. 1 includes four sides and has two bottom boards 12 with two top boards 14 secured thereto. In this example, the top boards 14 are nailed to the bottom boards 12 using standard industrial nails. Of course, any method of securement can be used, including screws, glue, staples, and the like.

Next, the shipping base is modified to secure the product to be shipped. As shown in FIG. 1, four holes 18 are drilled into the upper boards 14 of the shipping base 10. These holes 18 are designed to accommodate the legs of the product to be shipped. By placing the legs of the product in the holes 18, the shipping base 10 can minimize side-to-side movement of the product during transport.

A general description as well as a preferred embodiment of the present invention has been set forth above. Those skilled in the art to which the present invention pertains will recognize and be able to practice additional variations in the methods and apparatus described which fall within the teachings of this invention. Accordingly, all such modifications and additions are deemed to be within the scope of the invention which is only to be limited by the following claims.

1. A method of manufacturing a shipping base, the method comprising:
gathering siding materials for recycling;
cleaning the siding materials of any siding connectors;
cutting the siding materials to predetermined lengths; and
connecting the pre-determined lengths of siding materials to form a shipping base.

2. The method of manufacturing a shipping base of claim. 1 further comprising:
drilling holes in the shipping base to secure a product.

3. A method of manufacturing a shipping base, the method comprising:
forming a plurality of boards from a plurality of particles secured together with a resin;
cutting the boards to pre-determined lengths; and
assembling the boards to make a shipping base.

4. The method of manufacturing a shipping base of claim 3 wherein the resin is polymeric methylene diphenyl diisocyanate.

5. The method of manufacturing a shipping base of claim 3 further comprising:
drilling holes in the shipping base to secure a product.

6. A shipping base for transporting products, the shipping base comprising:
a plurality of non-wooden boards assembled to accommodate a product to be shipped;
a piece of styrofoam secured to one or more of the non-wooden boards between the boards and the product; and
a plurality of holes in the non-wooden boards to accommodate a portion of the product to be shipped.
